(19) United States
(12) Patent Application Publication
(10) Pub. No.: US 2004/0251874 A1
(43) Pub. Date: Dec. 16, 2004

(54) Method and apparatus for controlling the voltage of electrochemical cells in a rechargeable battery

(75) Inventor: Xavier Petitdidier, Poitiers (FR)

Correspondence Address: SUGHRUE MION, PLLC, 2100 PENNSYLVANIA AVENUE, N.W., SUITE 800, WASHINGTON, DC, 20037, US

(73) Assignee: SAFT, SA

(21) Appl. No.: 10/788,289

(22) Filed: Mar. 1, 2004

(30) Foreign Application Priority Data
Mar. 4, 2003 (FR) 0302605

(51) Int. Cl. H02J 7/00

(52) U.S. Cl. 320/118

(57) ABSTRACT

An apparatus is dedicated to controlling the voltage of a battery comprising at least two modules connected in series and each comprising at least one electrochemical cell, and each coupled to voltage balancing means. The apparatus comprises measurement means for determining first voltages across the terminals of each of the modules, calculation means for measuring a second voltage across the terminals of the battery and for determining a mean voltage per module representative of the second voltage divided by the number of modules, and processor means for comparing each measured first voltage with the mean voltage per module and for delivering to the balancing means signals representative of the result of the comparison whenever the first voltage of a module is greater than the mean voltage, such that the balancing means reduce the voltage across the terminals of the module.

The invention relates to the field of batteries of electrochemical cells, and more particularly to the field of apparatus for controlling the voltage of the electrochemical cells in certain rechargeable batteries.

### BACKGROUND OF THE INVENTION

As is known to the person skilled in the art, the voltage measured across the terminals of a battery depends on the state of charge of the electrochemical cells (also known as “secondary” or “rechargeable” cells, or even “accumulators”) which constitute modules of the battery. The state of charge of the electrochemical cells is thus subject to continuous monitoring by voltage control apparatuses. More precisely, such apparatuses are designed to ensure that the electrochemical cells are not subjected to overcharging or to deep discharges that reduce battery performance, and above all that limit battery lifetime.

This applies in particular to the voltage control apparatus described in patent document EP-0 691 725. That apparatus comprises n−1 regulators associated with n battery modules connected in series. More precisely, each regulator is associated with a pair of successive modules and comprises firstly a voltage comparator for comparing the values of the voltages measured across the terminals of each of the modules of the pair, and secondly a balancing circuit serving to divert a fraction of the current flowing through the module presenting the higher voltage to the module presenting the lower voltage, so that their respective voltages become substantially equal.

Such a mode of operation provides a real advantage compared with certain other known apparatuses because it enables voltage differences between successive modules to be limited. However under certain circumstances it can give rise to an accumulation of offsets between the various comparators that can lead to a maximum voltage difference between “balanced” modules that is equal to (n−1) times said offset. Consequently, that prior apparatus is suitable only for batteries having a small number of modules connected in series, typically fewer than eight (at greater numbers performance is generally degraded).

Other prior art apparatuses present the same drawback as that mentioned above and/or other drawbacks, such as for example, cost, complexity, or indeed power consumption.

Since no prior art apparatus provides entire satisfaction, the object of the invention is to improve the situation.

### OBJECTS AND SUMMARY OF THE INVENTION

To this end, the invention provides apparatus for controlling the voltage of a battery comprising at least two modules connected in series, each module comprising at least one electrochemical cell, and the modules being coupled to voltage balancing means.

The apparatus comprises:

measurement means for determining first voltages across the terminals of each of the modules to the battery;

calculation means for measuring a second voltage across the terminals of the battery and for determining a mean voltage per module, representative of the second voltage divided by the total number of modules; and

processor means arranged to compare each measured first voltage with the mean voltage per module and to send warning signals representative of the result of the comparison to the balancing means whenever the first voltage of a module is greater than the mean voltage so as to cause said balancing means to reduce the voltage across the terminals of the module.

Balancing now relies on comparisons that are independent of one another, so the maximum voltage difference between “balanced” modules is no greater than the voltage offset of the comparator means.

The control apparatus of the invention may comprise other characteristics which can be taken individually or in combination, and in particular:

processor means may be arranged in such a manner as to determine data representative of the difference between a measured first voltage and the mean voltage per module, and to add said difference data to the signals. In which case, the processor means send warning signals to the balancing means including the difference data so as to cause the balancing means to reduce the voltage across the terminals of the module in question by a value representative of the received difference;

the mean voltage per module which is delivered by the calculation means may be equal to the sum of an offset threshold value plus the ratio of the second voltage divided by the total number of modules;

the calculation means may comprise a set of resistors connected in series and equal in number to the number of modules, said set being connected to the terminals of the battery. When the modules are identical, the resistances of the resistors are likewise identical;

the processor means may be arranged in the form of processor elements each associated with a respective module and each serving to compare the first voltage as measured across the terminals of the associated module with the mean voltage per module, and to deliver warning signals representative of the result of the comparison at least on each occasion that the first voltage is greater than the mean voltage;

the balancing means may be optionally arranged in the form of balancing elements each associated with a respective module, and they are preferably arranged in such a manner as to ensure that the modules are balanced during charging and/or during discharging and/or at rest; and

when the processor means and the balancing means are respectively arranged in the form of processor elements and of balancing elements associated with respective modules, they may constitute respective control circuits associated with each module and independent from one another.

The invention also provides a battery comprising at least two electrochemical cell modules connected in series, each comprising at least one electrochemical cell, and the modules being coupled to a control apparatus of the type described above.

Furthermore, the invention is particularly adapted to batteries in which the electrochemical cells are selected from the group comprising at least: lithium cells, e.g. lithium/ion (Li/Ion) cells; silver/zinc cells; and polymer cells. However, in general manner, the invention applies to all batteries in which the various electrochemical cells need to present substantially the same voltage across their terminals in order to optimize performance.

The invention also provides a method of controlling the voltage of a battery comprising at least two modules connected in series, each module comprising at least one electrochemical cell.

The method consists firstly in determining first voltages across the terminals of each of the modules, secondly in measuring a second voltage across the terminals of the battery and then in determining a mean voltage per module representative of the second voltage divided by the number of modules, thirdly in comparing each measured first voltage with the mean voltage per module and in delivering signals representative of the result of the comparison each time a first voltage is greater than the mean voltage, and fourthly on receiving signals designating a module, in reducing the voltage across the terminals of the module concerned.

### BRIEF DESCRIPTION OF THE DRAWINGS

Other characteristics and advantages of the invention appear on examining the following detailed description and the accompanying drawings, in which:

FIG. 1 is a diagram of an embodiment of a rechargeable battery fitted with a control apparatus of the invention; and

FIG. 2 is a diagram of an embodiment of a control circuit for control apparatus of the invention.

### MORE DETAILED DESCRIPTION

The accompanying drawings contribute not only to describing the invention, but may also contribute to defining it, where appropriate.

The invention relates to controlling the voltage of a rechargeable battery comprising at least two modules connected in series, with each module comprising at least one electrochemical cell.

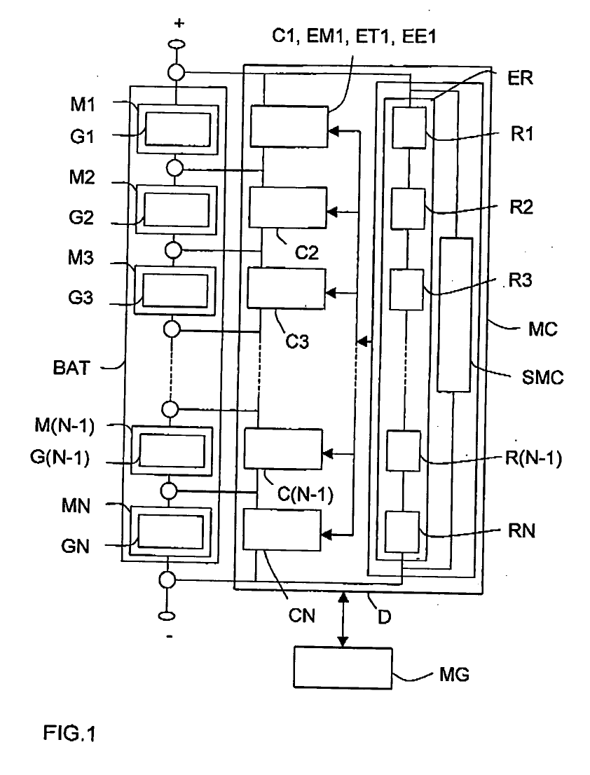

In the example shown in FIG. 1, the battery BAT comprises modules Mi (where i=1 to N, N not being less than 2; e.g. N=15), each module comprising an electrochemical cell Gi, e.g. a rechargeable lithium-ion (Li/Ion) type cell. However the invention also applies to batteries of modules Mi each comprising a plurality of electrochemical cells Gij connected in series and/or in parallel. Furthermore, the invention also applies to types of electrochemical cell other than lithium cells, and in particular it applies to silver/zinc cells and to polymer cells, and in general it applies to all batteries in which the various electrochemical cells need to present substantially the same voltage across their terminals in order to optimize performance.

The voltage of the battery BAT is controlled by a dedicated control apparatus D. The apparatus D preferably comprises as many control circuits Ci as there are modules Mi, together with calculation means MC coupled to the various control circuits Ci.

The calculation means MC are connected in parallel to the + and − terminals of the battery BAT. They preferably comprises a set ER of resistors Ri connected in series and equal in number to the number N of modules Mi, said set ER being connected to the + and − terminals of the battery BAT. When the modules Mi are identical, the N resistors Ri are of identical resistances. It is preferable to provide as many resistors as there are electrochemical cells.

The calculation means MC also comprise calculation submeans SMC connected to the terminals of the set of resistors ER and thus to the + and − terminals of the battery BAT. This calculation submeans SMC serve to measure the voltage UBAT across the terminals of the battery BAT and to determine a mean voltage per module UM representative of the ratio of the battery voltage UBAT divided by the total number N of modules Mi.

In certain situations, it can be preferable to deliver a mean voltage per module UM equal to the sum of an offset threshold value plus the ratio of the battery voltage UBAT divided by the total number N of modules Mi. That makes it possible to accommodate small voltage differences less than or equal to the selected offset, and consequently to avoid voltage control running away. The offset threshold can be used to stop discharging of the electrochemical cell Gi before its voltage reaches that of the electrochemical cell G(j) that presents the lowest voltage, regardless of its position within the battery BAT.

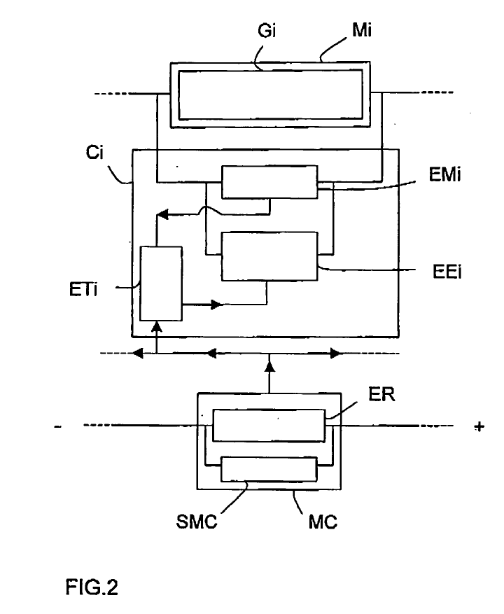

As shown more clearly in FIG. 2, each control circuit Ci is connected in parallel across the terminals of one of the modules Mi. It comprises firstly a measurement element EMi connected in parallel across the terminals of one of the modules Mi and serving to measure the (first) voltage U_{Mod} across the terminals of said module Mi.

The control circuit Ci also comprises a processor element ETi serving firstly to compare the measured module voltage UMOd as delivered by the associated measurement element EMi, with the mean voltage per module U_{M} as delivered by the calculation means MC, secondly to deliver warning signals representative of the result of its comparison when the voltage U_{Mod} is greater than the mean voltage per module U_{M}, and thirdly to send the warning signals to the balancing means so as to cause the balancing means to reduce the voltage across the terminals of the module Mi.

By way of example, the comparison may be performed by means of an operational amplifier circuit fed with voltages U_{Mod} and U_{M} respectively by the measurement element EMi and by the calculation means MC.

Preferably, and as shown in FIG. 2, the balancing means are implemented in the form of N balancing elements EEi each associated with a respective one of the modules Mi and each integrated in the corresponding control circuit Ci. The balancing element EEi is connected in parallel across the terminals of the associated module Mi. It serves to divert a fraction of the current flowing through the associated module Mi or to “consume” said current so that the voltage across its terminals becomes substantially equal to the mean voltage per module U_{M}. It serves to discharge the module Mi to which it is coupled so that its voltage (and thus the mean voltage per module U_{M}) tends as quickly as possible towards the lowest module voltage U_{Mod}. In a variant, the balancing element EEi may send an order to external means serving to obtain a regulated current or a higher current.

Thus, when one of the electrochemical cells Gi (e.g. the third cell G3) presents a voltage across its terminals equal to 3.6 volts (V), while the voltages across the terminals of the other cells Gi (i≠3) are equal to 3.7 V, then the processor means ETi (i≠3) instruct the balancing elements EEi (i≠3) with which they are respectively coupled to reduce the voltage across the terminals of the associated module Mi (i≠3) to 3.6 V.

In order to enable voltages to be balanced, two processes can be envisaged. A first process consists in determining data in the processor element ETi representative of the difference between the voltage U_{Mod} measured across the terminals of the associated module Mi and the mean voltage per module U_{M}, and then adding said data to the warning signal transmitted to the balancing element EEi so as to cause it to reduce the voltage across the terminals of the corresponding module Mi by a value representative of the difference that has been determined. Under such circumstances, the magnitude of the current bypassing the module Mi, or the length of time the module is bypassed, is selected by the balancing means EEi as a function of the received difference.

A second process consists merely in using the processor element ETi to send to the balancing element ETI data (or a warning signal) capable of taking two different values, e.g. “0” and “1” in on/off type operation, depending on whether discharging is or is not required. Thus, one of these values (e.g. “0”) informs the balancing element EEi that no action is to be undertaken, while the other value (e.g. “1”) is a warning signal requiring current to be diverted around the module Mi. This bypass current may have a pre-established magnitude or a pre-established duration. However it is also possible to consider that so long as the balancing element EEI receives a warning signal (“1”), it discharges the electrochemical cell Gi of the associated module Mi, and interrupts this balancing action as soon as it ceases to receive the warning signal.

The various balancing elements EEi are preferably arranged in such a manner as to balance the modules Mi continuously, i.e. during the stages of charging, discharging, and while at rest. However they could naturally be configured so as to operate during only one and/or two of those three stages.

The balancing element EEi may be made in any manner known to the person skilled in the art. More precisely, any means enabling energy to be diverted or consumed for the purpose of discharging the module Mi can be envisaged. It is thus possible to use a two-terminal circuit such as a resistor (included in the module Mi), a simple diode, or indeed a light-emitting diode (LED). Since voltage varies greatly in the region of the low threshold, it is easy to obtain effective rebalancing.

The balancing element EEi can even be an element external to the control apparatus D, providing it receives its instructions from the control means of said apparatus D. Furthermore, each control circuit Ci need not have its own balancing element EEi. Under such circumstances, the balancing function is performed by respective balancing means coupled to each of said modules Mi and also to the associated processor means ETi.

The control apparatus D may be coupled to a management unit MG dedicated to managing the end of charging and the end of discharging the various modules Mi. More precisely, it is coupled to the various processor elements ETi, and preferably also to the various balancing elements EEi, so as to be able to control the operation thereof when necessary. This can be useful in particular when balancing is taking place during a deep discharge.

It is important to observe that since the invention is intended to ensure that the various electrochemical cells Gi continuously present the same voltage, it suffices for the management unit MG to control a single circuit Ci, e.g. the first circuit C1 in order to control the end-of-charging state and the end-of-discharging state of the entire battery BAT. For example, with Li/Ion type cells, the end of charging can correspond to a voltage across the terminals of the first cell Gi that is equal to 4.1 V, whereas the end of discharging can correspond to a voltage across the terminals of the first cell G1 that is equal to 2.7 V.

The management unit MG which is not part of the invention can be implemented in any manner known to the person skilled in the art. All that is required is that it includes at least comparators, e.g. made using operational amplifiers, in order to compare the voltage of a module Mi with a threshold voltage.

Each control circuit Ci can be seen as an electronic circuit of the “1S” type. In other words, the control apparatus D of the invention can be considered as N voltage control circuits Ci of the IS type, coupled to the modules Mi and to calculation means MC connected in parallel across the terminals of the battery BAT.

However, as mentioned above, the control apparatus D of the invention may be constituted other than as an N×1S type apparatus. It can be implemented in the form of a single circuit comprising:

measurement means for determining the voltages U_{Mod} across the terminals of each of the modules Mi of the battery BAT;

calculation means for measuring the voltage U_{BAT} across the terminals of the battery BAT and for determining a mean voltage per module U_{M} representative of the battery voltage U_{BAT} divided by the total number N of modules Mi; and

processor means arranged in such a manner as to compare each measured module voltage U_{Mod} with the mean voltage per module U_{M}, then to deliver warning signals to balancing means EEi, where the warning signals are representative of the result of the comparison whenever the voltage of a module U_{Mod} is greater than the mean voltage U_{M}, so that the balancing means reduce the voltage across the terminals of said module Mi to which the warning applies (the balancing means optionally forming part of said control apparatus D).

The invention also provides a method of controlling the voltage of a battery BAT comprising at least two modules Mi connected in series and each comprising at least one electrochemical cell Gi.

The method may be implemented in particular by means of the above-described control apparatus D. The main and optional functions and sub-functions performed by the steps of the method are substantially identical to those performed by the various means constituting the control apparatus D so only the steps implementing the main functions of the method of the invention are summarized below.

The method consists firstly in determining first voltages across the terminals of each of the modules Mi, secondly in measuring a second voltage across the terminals of the battery BAT and in determining a mean voltage per module representative of the second voltage divided by the number N of modules Mi, thirdly in comparing each measured first voltage with the mean voltage per module and in delivering signals representative of the result of a comparison whenever a first voltage is greater than the mean voltage, and fourthly on receiving signals designating a module, in reducing the voltage across the terminals of the module in question Mi.

By means of the invention, genuinely effective balancing of the various electrochemical cell modules of the battery can be obtained.

In addition, the invention provides a voltage control apparatus that is independent of the power and the charging and discharging capacity of the battery.

In addition, the invention provides a voltage control apparatus that is capable of being modular without discontinuity as a function of the number of electrochemical cell modules in the battery.

Finally, the invention provides a voltage control apparatus that is easily connected to a battery and disconnected therefrom.

The invention is not limited to the embodiments of control apparatuses and batteries as described above merely by way of example, but covers any variant that the person skilled in the art can envisage within the ambit of the following claims.

What is claimed is:

1. An apparatus for controlling the voltage of a battery comprising at least two modules connected in series, each module comprising at least one electrochemical cell, and each module being coupled to voltage balancing means, the apparatus comprising measurement means suitable for determining first voltages across the terminals of each of said modules, calculation means suitable for measuring a second voltage across the terminals of said battery and for determining a mean voltage per module representative of said second voltage divided by the number of modules, and processor means arranged to compare each measured first voltage with said mean voltage per module and then to send to said balancing means signals representative of the result of a comparison whenever the first voltage of a module is greater than the mean voltage, so that the balancing means reduce the voltage across the terminals of said module.

2. An apparatus according to claim 1, wherein said processor means are arranged to determine data representative of the difference between the first voltage measured across the terminals of the module and said mean voltage per module, and to accompany said signals with said data, such that said balancing means reduce the voltage across the terminals of said module by a value representative of said determined difference.

3. An apparatus according to claim 1, wherein said mean voltage per module as delivered by said calculation means is equal to the sum of an offset threshold value plus the ratio of said second voltage divided by said number of modules.

4. An apparatus according to claim 1, wherein said calculation means comprise a set of resistors connected in series, the number of resistors is equal to the number of modules, and the set being connected in parallel across the terminals of said battery.

5. An apparatus according to claim 4, wherein, when said modules are identical, said resistors are of identical resistance.

6. An apparatus according to claim 1, wherein said processor means are arranged in the form of processor elements each associated with a respective module and each suitable for comparing the first voltage as measured across the terminals of the associated module with said mean voltage per module and for delivering signals representative of the result of the comparison at least whenever said first voltage is greater than said mean voltage.

7. An apparatus according to claim 1, including said balancing means.

8. An apparatus according to claim 7, wherein said balancing means are arranged in the form of balancing elements each associated with a respective module.

9. An apparatus according to claim 6, including said balancing means arranged in the form of balancing elements each associated with a respective module, and wherein the processor element and the balancing element associated with a given module together constitute a control circuit, said control circuits associated with the various modules being independent from one another.

10. An apparatus according to claim 7, wherein said balancing means are arranged to balance said modules during charging and/or during discharging and/or while at rest.

11. A battery comprising at least two modules connected in series and each comprising at least one electrochemical cell, the battery including a control apparatus for controlling the voltage of said battery, each module being coupled to voltage balancing means, the apparatus comprising measurement means suitable for determining first voltages across the terminals of each of said modules, calculation means suitable for measuring a second voltage across the terminals of said battery and for determining a mean voltage per module representative of said second voltage divided by the number of modules, and processor means arranged to compare each measured first voltage with said mean voltage per module and then to send to said balancing means signals representative of the result of a comparison whenever the first voltage of a module is greater than the mean voltage, so that the balancing means reduce the voltage across the terminals of said module.

12. A battery according to claim 11, wherein each electrochemical cell is selected from a group comprising at least: lithium cells, and in particular lithium/ion cells; silver/zinc cells; and polymer cells.

13. A battery according to claim 11, wherein said processor means are arranged to determine data representative of the difference between the first voltage measured across the terminals of the module and said mean voltage per module, and to accompany said signals with said data, such that said balancing means reduce the voltage across the terminals of said module by a value representative of said determined difference.

14. A battery according to claim 11, wherein said mean voltage per module as delivered by said calculation means is equal to the sum of an offset threshold value plus the ratio of said second voltage divided by said number of modules.

15. A battery according to claim 11, wherein said processor means are arranged in the form of processor elements each associated with a respective module and each suitable for comparing the first voltage as measured across the terminals of the associated module with said mean voltage per module and for delivering signals representative of the result of the comparison at least whenever said first voltage is greater than said mean voltage.

16. A method of controlling the voltage of a battery comprising at least two modules connected in series and each comprising at least one electrochemical cell, the method consisting: i) in determining first voltages across the terminals of each of said modules; ii) in measuring a second voltage across the terminals of said battery and in determining a mean voltage per module representative of said second voltage divided by the number of modules; iii) in comparing each measured first voltage with said mean voltage per module and in delivering signals representative of the result of the comparison whenever the first voltage of a module is greater than the mean voltage; and iv) on receiving signals designating a module, in reducing the voltage across the terminals of said module.

17. A method according to claim 16, wherein data is determined representative of the difference between a measured first voltage and said mean voltage per module, and said data is added to said signals, and on receiving said signals designating a module, the voltage across the terminals of the module in question is reduced by a value representative of said determined difference.
